(19) United States
(12) Patent Application Publication
(10) Pub. No.: US 2022/0099808 A1
(43) Pub. Date: Mar. 31, 2022

(54) SETTING A SCANNING ACTION OF LIDAR SENSORS

(71) Applicant: Robert Bosch GmbH, Stuttgart (DE)

(72) Inventors: Mustafa Kamil, Ludwigsburg (DE); Remigius Has, Grafenau-Daetzingen (DE)

(21) Appl. No.: 17/484,319

(22) Filed: Sep. 24, 2021

(30) Foreign Application Priority Data
Sep. 30, 2020 (DE) 10 2020 212 324.1

(51) Int. Cl. G01S 7/481; G01S 17/931

(52) U.S. Cl. CPC G01S 7/4817; G01S 17/931

(57) ABSTRACT

A method for setting a scanning action of at least one LIDAR sensor by a control unit. Measured data of the LIDAR sensor are received, and at least one parameter is ascertained. A scanning action of the LIDAR sensor is adapted, based on the ascertained parameter or in a time-dependent manner. A control unit is also described.

### FIELD

The present invention relates to a method for setting a scanning movement of at least one LIDAR sensor by a control unit. The present invention also relates to a control unit.

### BACKGROUND INFORMATION

The use of LIDAR sensors in the field of automobiles is necessary for implementing different driver assistance functions and automated driving functions. Scanning or rotating LIDAR sensors are normally used, which scan a scanning area using a collimated laser beam.

In particular, LIDAR sensors designed as rotating macroscanners may detect a large horizontal scanning area. One part of the LIDAR sensor is situated on a rotor and rotated or pivoted to scan the scanning area. For example, the transmitting unit as well as the receiving unit of the LIDAR sensor may also be situated on the rotor. Alternatively a beam deflection by a mirror may alternatively be situated on a rotor, depending on the design of the LIDAR sensor.

A multiplicity of LIDAR sensors is necessary, in particular for implementing automated driving functions. The detecting areas or scanning areas of these LIDAR sensors often overlap and may interfere with each other. This problem occurs, for example, in structurally identical or technologically similar LIDAR sensors and may result in an increased number of detection errors or in a detector saturation or blooming.

### SUMMARY

An object of the present invention is to provide a method for operating LIDAR sensors, which reduces or eliminates a mutual interference of multiple LIDAR sensors or an interference caused by external influences.

This object may be achieve with the aid of the present invention. Advantageous embodiments of the present invention are disclosed herein.

According to one aspect of the present invention, a method is provided for setting a scanning action of at least one LIDAR sensor by a control unit.

In particular, it is possible to set the scanning action of at least one LIDAR sensor within range of at least one further LIDAR sensor or within range of an external disturbance source, for example a laser pointer. The at least one LIDAR sensor may preferably be designed as a scanning LIDAR sensor and thus include a rotor, which rotates a mirror or the receiving unit and the transmitting unit in order to detect a scanning area.

In one step, measured data of the LIDAR sensor are received. At least one parameter is ascertained, based on the received measured data.

The scanning action of the LIDAR sensor is subsequently adapted, based on the ascertained parameter. Alternatively, the scanning action of the at least one LIDAR sensor is adapted in a time-dependent manner, the parameters not being ascertained or being ignored.

According to another aspect of the present invention, a control unit is provided, which is configured to carry out the method according to the present invention.

In the case of a too frequently occurring systematic disturbance of a LIDAR sensor, an adaptation of the rotor position, and thus of the splitting emission direction, may be implemented by the method, with the goal of implementing a direct disturbance suppression. The adaptation of the rotor position may set the scanning action of the LIDAR sensor by a change in a rotational speed, a scanning frequency along the rotation and the like. In each rotation, detection errors of the same type may be minimized or eliminated in certain solid angles of the 3D point cloud.

Moreover, as an additional degree of freedom, the probability of a mutual influencing of LIDAR sensors in road applications is to be minimized by a multiplicity of identical or similar LIDAR sensors or ruled out by a high-frequency, adaptive regulation.

With the aid of a control or a regulation, the previous time-invariant and deterministic, and thus easily and repeatedly disturbable scanning action of macroscanners, may be transformed into a time-variant, adaptively settable scanning action with regard to minimal crosstalk probability. Due to the method, the probability of a crosstalk of structurally identical or similar LIDAR sensors, in particular, may be minimized, and the variability of the horizontal scanning may be set by intelligently used offsets of the rotor zero position upon startup of the LIDAR sensor, during operation or upon shutdown of the LIDAR sensor.

This provides the possibility of integrating a greater number of structurally identical LIDAR sensors in a vehicle or in particularly small vehicles, as well as to operate LIDAR sensors in heavy road traffic including many different LIDAR sensors used.

The temporal system performance or scanning action of the LIDAR sensor may be varied depending on the situation or adaptively to minimize or eliminate disturbances.

The method may be implemented with little implementation complexity, since no encryption methods are needed to implement a manipulation protection against external interferences. The setting of the scanning action may be implemented by control commands of the control unit, which activate a driver of the rotor and/or a driver of a transmitting unit for generating laser beams. Additional hardware may thus be eliminated.

In one specific embodiment, the scanning action of the LIDAR sensor is temporally varied in the form of a scanning frequency or in the form of a rotational speed of the LIDAR sensor by a linear or non-linear function. Such a control of the scanning action takes place investigatively or without a measurement of parameters or without a feedback of the settings made.

Such a control of the scanning action may take place by fixedly specifying the time, for example by a changing of the rotor zero position increasing linearly or according to a higher-order function during the operation of the LIDAR sensor. Due to this measure, interferences due to unwanted or malicious effect of external light or jamming may be minimized, and a reliable operation of a LIDAR sensor may be facilitated.

According to a further exemplary embodiment of the present invention, a crosstalk frequency of a detector of the LIDAR sensor, the number of external sensors or disturbance sources, a false-positive rate, a false-negative rate, an existence probability of objects of reduced dimensions in the scanning area and/or a frequency of reflections in a free space may be ascertained as at least one parameter. With the aid of the ascertained parameters, a feedback of the LIDAR sensor may be determined and a comprehensive regulation of the scanning action of the LIDAR sensor may be implemented. In particular, systematic disturbances of the LIDAR sensor may be minimized by a regulation of this type.

According to a further specific embodiment of the present invention, the scanning action of the LIDAR sensor is varied by an activation of a motor driver of a rotor of the LIDAR sensor and/or by an activation of a driver of a transmitting unit. A technically simple setting of the scanning action is possible hereby. For example, the motor driver may operate the rotor at a reduced frequency or a reduced power to lower a rotational speed. Alternatively, the rotational speed may be increased, or an energizing or a power supply of the rotor may be temporarily interrupted.

In particular, the scanning action of the LIDAR sensor may be set in a temporally invariant manner to eliminate systematic disturbances or interferences.

According to a further exemplary embodiment of the present invention, a variation of a start point in time of a rotation of the rotor, at least one interruption of a power supply of the rotor, a temporary acceleration of the rotor or a temporary braking of the rotor is carried out to vary the scanning action of the LIDAR sensor. A versatile and flexible influencing of the scanning action of the LIDAR sensor is possible hereby.

According to a further specific embodiment of the present invention, the scanning action of a first LIDAR sensor is set by a synchronization with at least one second LIDAR sensor. Due to this measure, a synchronization or a controlled desynchronization of the LIDAR sensors may be implemented during the operation of multiple LIDAR sensors to minimize or eliminate mutually disturbing influences of the LIDAR sensors on each other.

According to a further exemplary embodiment of the present invention, a time signal is generated by the control unit, the time signal being transmitted to the first LIDAR sensor and to the second LIDAR sensor via a communication link to synchronize or to desynchronize the first LIDAR sensor and the second LIDAR sensor. Due to this measure, an external temporal synchronization is possible in the case of a regulation of the scanning action of the LIDAR sensors. An external timer, such as a so-called GPS master clock of the control unit, or a timer of one of the LIDAR sensors, synchronizes further LIDAR sensors continuously via a fast, external trigger interface. The specification of the time signals may take place continuously, so that changes to the scanning action are taken over directly from all LIDAR sensors.

According to a further specific embodiment of the present invention, the first LIDAR sensor and the second LIDAR sensor each include an internal pulse generator, the internal pulse generators being set by a clock signal generated by the control unit at equal time intervals, at different time intervals or as needed. This allows the external timer to coordinate the LIDAR sensors at defined intervals or if a setting of the scanning action is made using an adapted time signal. The particular internal timers of the LIDAR sensors then retain the defined specification up to a further time signal. The internal timers of the LIDAR sensors may be designed, for example, as quartz-clocked FPGAs.

According to a further exemplary embodiment of the present invention, a scanning frequency of the first LIDAR sensor is increased or reduced with respect to a scanning frequency of the second LIDAR sensor. Due to this measure, remaining inaccuracies of the temporal synchronization of pulsed laser beams of multiple LIDAR sensors may be compensated for.

In particular, jitters of the rotor zero position may be compensated for by slightly longer desynchronization or an enlarged angular gap between two LIDAR sensors. The jitter tolerance when operating multiple LIDAR sensors in parallel is also increased hereby.

Alternatively or additionally, the presence of offsets of the rotor zero position may be compensated for by intrinsic calibration to carry out a more precise setting of the scanning action of the LIDAR sensors.

Preferred exemplary embodiments of the present invention are explained in greater detail below, based on highly simplified schematic representations.

### BRIEF DESCRIPTION OF THE DRAWINGS

FIG. 1 shows a schematic top view of an arrangement including two LIDAR sensors, which interfere with each other, to illustrate a method according to one specific embodiment of the present invention.

FIG. 2 shows a schematic top view of an arrangement including two LIDAR sensors to illustrate a method according to one specific embodiment of the present invention.

FIG. 3 shows a schematic 3D point cloud for illustrating an effect of two LIDAR sensors, which interfere with each other.

### DETAILED DESCRIPTION OF EXAMPLE EMBODIMENTS

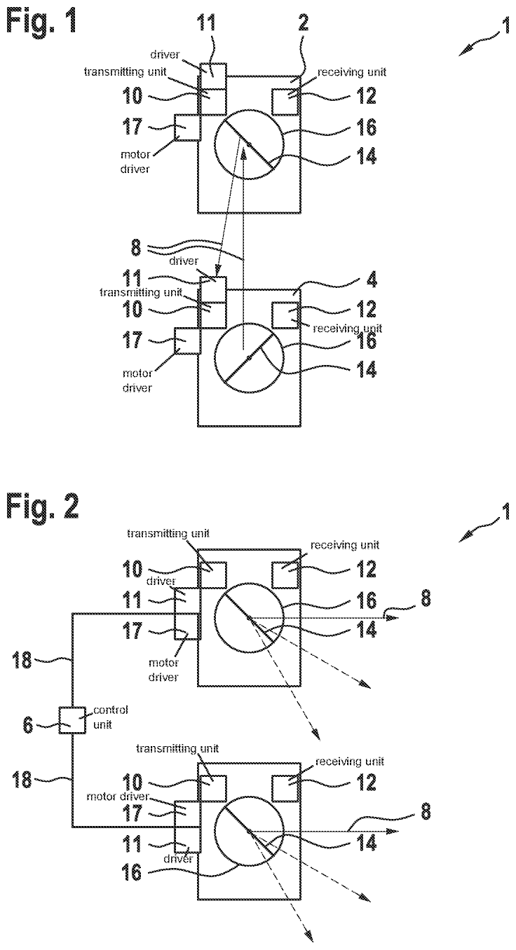

FIGS. 1 and 2 show schematic top views of arrangements 1, including two LIDAR sensors 2, 4, for the purpose of carrying out a method for setting a scanning action of at least one LIDAR sensor 2, 4 by a control unit 6. FIG. 1 shows a schematic top view of an arrangement 1, including two LIDAR sensors 2, 4, which interfere with each other.

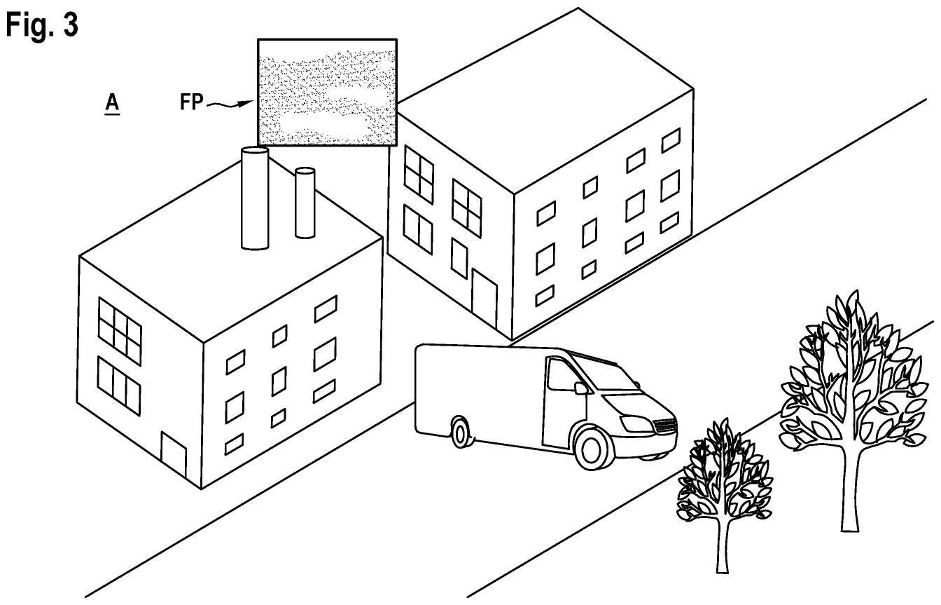

FIG. 3 shows a schematic 3D point cloud for illustrating an effect of two LIDAR sensors 2, 4, which interfere with each other. In particular, an overriding of receiving units 12 of LIDAR sensors 2, 4, due to false-positive measurements FP, is recognizable in an open space or in an otherwise undeveloped area of scanning area A, which results from the receipt of generated beams 8 of neighboring sources.

Beams 8 generated by LIDAR sensors 2, 4 are emitted into a scanning area. LIDAR sensors 2, 4 are designed, for example, as structurally identical or technically similar LIDAR sensors 2, 4 and include transmitting units 10, which are activated by a driver 11 for generating beams 8.

LIDAR sensors 2, 4 furthermore include receiving units 12 for receiving beams reflected or scattered back out of scanning area A.

A mirror 14, which is situated on a rotor 16, is provided for deflecting the generated beams into scanning area A. Rotor 16 is activated by a motor driver 17.

FIG. 2 shows a top view of two LIDAR sensors 2, 4, which are synchronized with each other by a control unit 6 in such a way that generated beams 8 do not result in an interference.

For example, control unit 6 may control the rotor position of rotor 16, and thus that of mirror 14 of one LIDAR sensor 2 or both LIDAR sensors 2, 4, via motor driver 17 by specifying the time via a rising rotor zero position during the operation of LIDAR sensors 2, 4. In particular, the scanning action may be set in a time-invariant manner to avoid a regular or systematic disturbance.

Alternatively, control unit 6 may receive measured data from at least one LIDAR sensor 2, 4 and ascertain at least one parameter, which is used as a basis for a changing of the scanning action of the at least one LIDAR sensor 2, 4. A regulation of this type makes it possible to also set the rotor position of rotor 16, based on re-measurements of certain parameters, such as a crosstalk frequency, false-positive results, false-negative results, reflection frequency in free space and the like.

LIDAR sensors 2, 4 may be intelligently controlled or regulated by control unit 6 in such a way that a temporally variable scanning action is implemented. For this purpose, the start point in time of the rotation of rotor 16 during the startup of LIDAR sensors 2, 4 as well as a short interruption of the motor energizing by motor driver 17 during the operation of LIDAR sensors 2, 4 may be initiated to change the scanning action.

LIDAR sensors 2, 4 may be installed, for example, in a vehicle, in a public infrastructure or an industrial infrastructure.

Moreover, LIDAR sensors 2, 4 may be installed in different vehicles positioned adjacent to each other.

Control unit 6 may thus influence the scanning action of one or of multiple LIDAR sensors 2, 4. This may take place via a hardwired or a wireless communication link 18 between control unit 6 and at least one LIDAR sensor 2, 4.

1-10. (canceled)

11. A method for setting a scanning action of at least one LIDAR sensor by a control unit, the method comprising the following steps:
receiving measured data of the LIDAR sensor and ascertaining at least one parameter; and
adapting a scanning action of the LIDAR sensor, based on the ascertained parameter or in a time-dependent manner.

12. The method as recited in claim 11, wherein the scanning action of the LIDAR sensor is temporally varied in scanning frequency or in rotational speed of a rotor of the LIDAR sensor, by a linear or non-linear function.

13. The method as recited in claim 11, wherein a crosstalk frequency of a detector of a receiving unit of the LIDAR sensor, and/or a number of external sensors or disturbance sources, and/or a false-positive rate, and/or a false-negative rate, and/or an existence probability of objects of reduced dimensions in a scanning area, and/or a frequency of reflections in a free space, is ascertained as the at least one parameter.

14. The method as recited in claim 11, wherein the scanning action of the LIDAR sensor is varied by an activation of a motor driver of the rotor and/or by an activation of a driver a transmitting unit of the LIDAR sensor, based on the ascertained parameter.

15. The method as recited in claim 14, wherein a changing of a start point in time of a rotation of the roto, or at least one interruption of a power supply of the rotor, or a temporary acceleration of the rotor, or a temporary braking of the rotor, is carried out to vary the scanning action of the LIDAR sensor.

16. The method as recited in claim 11, wherein a scanning action of a first LIDAR sensor is set by a synchronization with a scanning action of at least one second LIDAR sensor.

17. The method as recited in claim 16, wherein a time signal is generated by the control unit, the time signal being transmitted to the first LIDAR sensor and to the second LIDAR sensor via a communication link to synchronize or to desynchronize the first LIDAR sensor and the second LIDAR sensor.

18. The method as recited in claim 16, wherein the first LIDAR sensor and the second LIDAR sensor each include an internal pulse generator, the internal pulse generators being set by a clock signal generated by the control unit at equal time intervals, or at different time intervals, or as needed.

19. The method as recited in claim 16, wherein a scanning frequency of the first LIDAR sensor is increased or reduced with respect to a scanning frequency of the second LIDAR sensor.

20. A control unit configured to set a scanning action of at least one LIDAR sensor by a control unit, the control unit configured to:
receive measured data of the LIDAR sensor and ascertain at least one parameter; and
adapt a scanning action of the LIDAR sensor, based on the ascertained parameter or in a time-dependent manner.
